(19) United States
(12) Patent Application Publication
(10) Pub. No.: US 2014/0316959 A1
(43) Pub. Date: Oct. 23, 2014

(54) ESTIMATING FINANCIAL RISK BASED ON NON-FINANCIAL DATA

(71) Applicant: INTERNATIONAL BUSINESS MACHINES CORPORATION, Armonk, NY (US)

(72) Inventors: John F. Bisceglia, Fairfield, CT (US); Wesley M. Gifford, New Canaan, CT (US); Anshul Sheopuri, White Plains, NY (US); Rose M. Williams, Wappinger Falls, NY (US)

(73) Assignee: International Business Machines Corporation, Armonk, NY (US)

(21) Appl. No.: 13/865,703

(22) Filed: Apr. 18, 2013

(51) Int. Cl. G06Q 40/00

(52) U.S. Cl. CPC G06Q 40/00
USPC 705/35

(57) ABSTRACT

A method for estimating a risk associated with a project includes preparing a plurality of data models, where each of the plurality of data models examines a different dimension of the project, classifying each of the plurality of data models to produce a plurality of prediction models, where each of the plurality of prediction models is defined by a plurality of quality metrics, and where the plurality of quality metrics includes a preliminary estimate of the risk and a measure of confidence in the preliminary estimate, and computing a refined estimate of the risk based on a quality of the plurality of quality metrics.

### BACKGROUND OF THE INVENTION

The present invention relates generally to risk estimation and relates more specifically to financial risk estimation for services projects for which financial data is limited or unavailable.

Often in the early stages of a project's life cycle, significant costs are incurred as the project starts up. At the same time, however, little (if any) revenue is generally posted until the project begins to meet agreed upon deliverables. It is therefore difficult to reliably predict risk until the project has posted at least a minimum amount of solid revenue and cost data (e.g., six months' worth) outside of the initial start up period. There also tends to be very little data available that reflects actual risk issues already encountered during the early stages of the project (such as schedule adherence).

What is more, the data that is available in the early stages of a project is not always reliable. For instance, risk assessments made during a project proposal are often overly optimistic, and therefore underestimate the problems that a project is likely to experience shortly following project launch (such as staffing).

### SUMMARY OF THE INVENTION

A method for estimating a risk associated with a project includes preparing a plurality of data models, where each of the plurality of data models examines a different dimension of the project, classifying each of the plurality of data models to produce a plurality of prediction models, where each of the plurality of prediction models is defined by a plurality of quality metrics, and where the plurality of quality metrics includes a preliminary estimate of the risk and a measure of confidence in the preliminary estimate, and computing a refined estimate of the risk based on a quality of the plurality of quality metrics.

A system for estimating a risk associated with a project includes a processor and a computer readable storage medium that stores instructions which, when executed, cause the processor to perform operations including preparing a plurality of data models, where each of the plurality of data models examines a different dimension of the project, classifying each of the plurality of data models to produce a plurality of prediction models, where each of the plurality of prediction models is defined by a plurality of quality metrics, and where the plurality of quality metrics includes a preliminary estimate of the risk and a measure of confidence in the preliminary estimate, and computing a refined estimate of the risk based on a quality of the plurality of quality metrics.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating one embodiment of a system for estimating financial risk, according to the present invention;

FIG. 2 is a flow diagram illustrating one embodiment of a method for estimating financial risk associated with a project, according to the present invention; and

FIG. 3 is a high-level block diagram of the risk estimation method that is implemented using a general purpose computing device.

### DETAILED DESCRIPTION

In one embodiment, the invention is a method and apparatus for estimating financial risk based on non-financial data. Although sufficient financial data is typically not available for projects in the early stages (e.g., first four to five months following inception), other pre- and post-launch project data can offer insight into potential risks if modeled appropriately using correct statistical techniques. Embodiments of the invention create a variable that represents financial risk derived from project proposal risk assessments and/or initial project health assessments (if available). A resultant financial risk index can be used to prioritize projects that are in the early stages of development, when indicators of risk are dynamically changing and data quality is changing over time. A new indicator is also generated that can be provided as an input into remaining development cycles as the risk estimate matures. Risk estimates can be revised as new indicators are made available, without rebuilding the models.

In further embodiments, the performance of the model can be measured, and its predictions can be weighted. The weights are used to normalize assumptions based on model accuracy and the reliability of new prediction metrics.

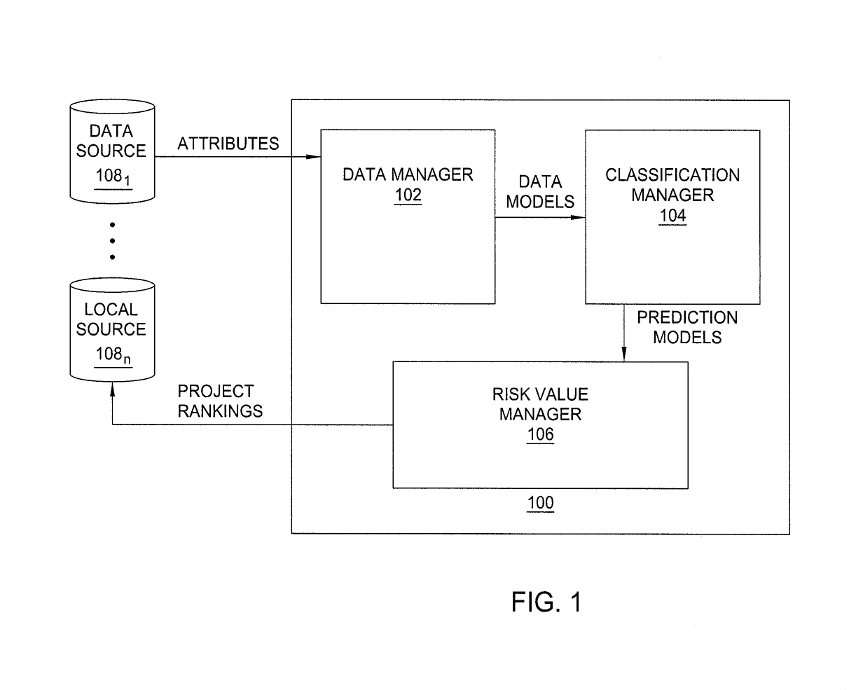

FIG. 1 is a block diagram illustrating one embodiment of a system 100 for estimating financial risk, according to the present invention. The system 100 takes as inputs data about a plurality of projects (e.g., non-financial data) and generates as an output a prioritized list of the projects, ranked according to estimated financial risk. As illustrated, the system 100 generally comprises a data manager 102, a classification manager 104, and a risk value manager 106. Any of these components 102-106 may comprise a processor. In addition, the system 100 has access to a plurality of data sources or databases 108₁-108ₙ (hereinafter collectively referred to as “data sources 108”) storing data about the projects being evaluated. The data sources 108 include attributes (e.g., historical data) of the projects being evaluated, including pre- and post-project launch data. In addition, the data sources 108 may store risk predictions made by the system 100.

The data manager 102 extracts data from the source system for each of a plurality of projects to be evaluated and stores the extracted data locally. The extracted data is used to prepare a plurality of data models used for data mining. In one embodiment, each of the data models comprises a project survey that examines a different non-financial dimension of the project. For instance, the project surveys may include one or more of the following: a project proposal risk survey (e.g., conducted before the launch of the project), a contract risk survey (e.g., conducted before the launch of the project), a standard project assessment (e.g., conducted by the project manager approximately thirty to sixty days after the project is launched), a detailed project risk assessment (e.g., conducted by a risk management expert approximately ninety days after the project is launched), or an overall ongoing assessment (e.g., conducted after the project is launched to provide a quick overview of key aspects of the project's status). In one embodiment, the prediction accuracy of the system 100 directly proportional to the number of data models used.

In one embodiment, data that is extracted for use in the models pertaining to pre-launch activities includes total counts of the risk scores that are generated from the survey answers. In one embodiment, the counts are categorized on a scale that specifies varying levels of contract or project risk (e.g., extremely high risk, high risk, medium risk, or low risk).

In one embodiment, data that is extracted for use in the models pertaining to post-launch activities includes rubric grades (e.g., letter grades on a scale from A through D, where A is the highest possible grade and D is the lowest possible grade) in a plurality of standard project categories. In one embodiment, the standard project categories are focused on measuring progress in staffing, project scope, schedule adherence, managed project risk, stakeholder commitment, and delivery provider benefits. In addition, an overall score that aggregates the standard project categories may be assigned (e.g., using the same rubric, such as the letter grades). The surveys relating to post-launch activities focus on at least two different project perspectives: the day-to-day project manager perspective (e.g., the perspective of the immediate stakeholder) and the delivery organization's risk management expert perspective (e.g., the perspective of the risk management community).

In one embodiment, data that is extracted for use in the models that develop an overall ongoing assessment includes total counts of the risk scores (e.g., categorized on the scale used to score the pre-launch surveys) and an overall score (e.g., graded on the rubric used to grade the post-launch surveys).

The classification manager 104 receives the data models from the data manager 102 and classifies each of the models to produce a prediction model. Each resultant prediction model is defined by a plurality of model quality metrics. In one embodiment, the model quality metrics include one or more of: prediction score (e.g., a preliminary estimate of risk), prediction confidence, project identifiers, and classification algorithm attributes. Each of the model quality metrics is tested for overall quality, reliability, and accuracy. Weights are derived from the testing of the model quality metrics and assigned to the associated prediction models. In one embodiment, one distinct prediction model is produced for each data model provided by the data manager 102; however, in further embodiments, additional prediction models can be produced to accommodate future data.

The risk value manager 106 receives the prediction models from the classification manager 104 and aggregates the prediction models in a single data structure (e.g., a table). The single data structure includes, for each prediction model, one or more of the following items: project identifiers, names of prediction model, prediction, prediction confidence score, and assigned weight. In addition, the risk value manager 106 computes a score that indicates the financial risk of each project (e.g., a refined estimate). In one embodiment, the score is computed by multiplying the prediction confidence of the project's associated prediction model by the associated prediction model's weight. Based on the score, the risk value manager assigns a flag to the project that indicates a risk level of the project (e.g., scored on a scale of very high risk to low risk). The score and the flag are both stored in the data structure, along with at least the project identifiers. In one embodiment, the data structure ranks or prioritizes the evaluated projects according to the estimated risk of each project.

The system 100 therefore assesses a plurality of projects in order to rank the projects according to their estimated level of risk. This information in turn will help project managers to better determine which projects should receive the most attention and/or resources. Thus, the ranked list produced by the system 100 allows managers to better allocate resources among multiple projects.

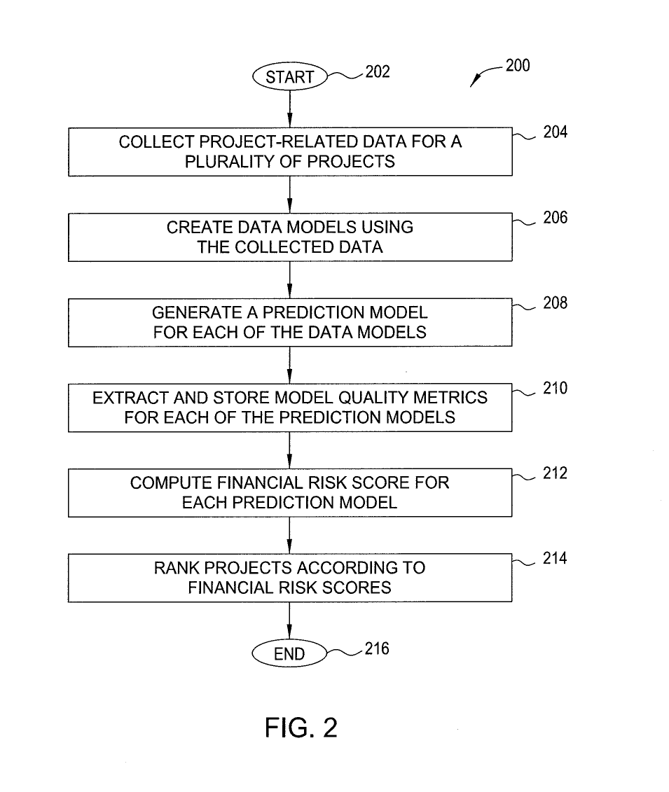

FIG. 2 is a flow diagram illustrating one embodiment of a method 200 for estimating financial risk associated with a project, according to the present invention. The method 200 may be performed, for example, by the system 100 illustrated in FIG. 1. As such, reference is made in the discussion of the method 200 to various items illustrated in FIG. 1. However, the method 200 is not limited by the configuration of the system 100 illustrated in FIG. 1.

The method 200 begins in step 202. In step 204, the data manager 102 collects project-related data for a plurality of projects (e.g., from one or more of the databases 108). In one embodiment, the project-related data includes project pre- and post-launch data, such as project proposal assessment data and post-launch project health data, as discussed above.

In step 206, the data manager 102 prepares a plurality of data models using the data collected in step 204. In one embodiment, each of the data models is prepared by completing a project survey that examines a different non-financial dimension of the project, as discussed above. For instance, the project surveys may include one or more of the following: a project proposal risk survey (e.g., conducted before the launch of the project), a contract risk survey (e.g., conducted before the launch of the project), a standard project assessment (e.g., conducted by the project manager approximately thirty to sixty days after the project is launched), a detailed project risk assessment (e.g., conducted by a risk management expert approximately ninety days after the project is launched), or an overall ongoing assessment (e.g., conducted after the project is launched to provide a quick overview of key aspects of the project's status).

In one embodiment, creation of the data models includes creating one or more target variables for each data set collected in step 204. In one embodiment, the target variables include, for data pertaining to pre-launch activities, total counts of the risk scores that are generated from the survey answers (e.g., categorized on a scale that specifies varying levels of contract or project risk). In one embodiment, the target variables include, for data pertaining to post-launch activities, rubric grades in a plurality of standard project categories (e.g., staffing, project scope, schedule adherence, managed project risk, stakeholder commitment, and delivery provider benefits). In addition, an overall score that aggregates the standard project categories may be assigned (e.g., using the same rubric). In one embodiment, the target variables include, for data pertaining to the overall ongoing assessment, total counts of the risk scores (e.g., categorized on the scale used to score the pre-launch surveys) and an overall score (e.g., graded on the rubric used to grade the post-launch surveys).

In step 208, the classifier manager 104 runs and builds prediction models per for each of the data models created in step 206. In one embodiment, one prediction model is generated for each data model. In step 210, the classifier manager 104 extracts and stores (e.g., in a single table or other data structure), for each of the prediction models, a plurality of model quality metrics, field correlations, target variable predictions, and probabilities. As discussed above, the model quality metrics include one or more of: prediction score, prediction confidence, project identifiers, and classification algorithm attributes. Each of the model quality metrics is tested for overall quality, reliability, and accuracy. Weights or probabilities are derived from the testing of the model quality metrics and assigned to the associated prediction models.

In step 212, the classifier manager 104 extracts and stores (e.g., in a single table or other data structure), for each of the prediction models, project identifiers, target variable predictions, probabilities, and other key metrics. In one embodiment, the data extracted in steps 210 and 212 is stored in the same data structure.

In step 214, the risk value manager 106 computes a financial risk score for each of the prediction models. In one embodiment, the financial risk score for a prediction model is computed by running a weighting algorithm over the predicted variables and their associated probabilities. For instance, the score may be computed by multiplying the prediction confidence of the prediction model by the associated prediction model's weight.

In step 216, the risk value manager 106 ranks and prioritizes the projects in accordance with the financial risk scores computed in step 214. For instance, the projects may be ranked from lowest estimated risk to highest estimated risk. In one embodiment, the risk value manager 106 stores the rankings in a table or other data structure. This data structure may be output to a database 108.

The method 200 ends in step 218.

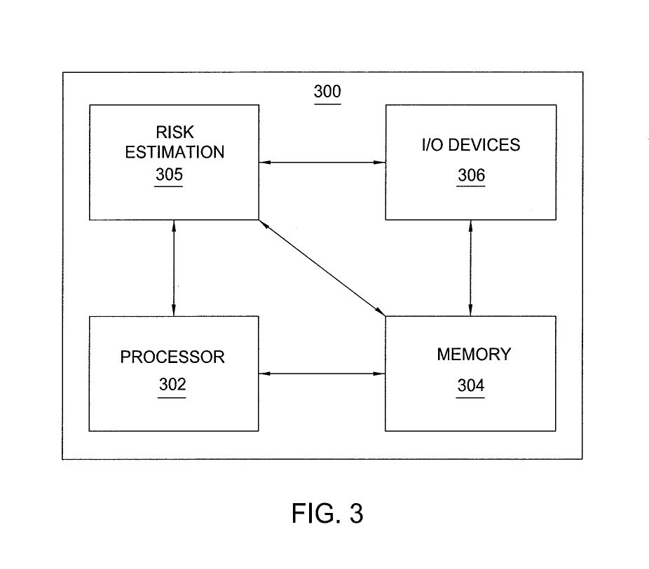

FIG. 3 is a high-level block diagram of the risk estimation method that is implemented using a general purpose computing device 300. The general purpose computing device 300 may comprise, for example, a portion of the system 100 illustrated in FIG. 1. In one embodiment, a general purpose computing device 300 comprises a processor 302, a memory 304, a risk estimation module 305 and various input/output (I/O) devices 306 such as a display, a keyboard, a mouse, a stylus, a wireless network access card, an Ethernet interface, and the like. In one embodiment, at least one I/O device is a storage device (e.g., a disk drive, an optical disk drive, a floppy disk drive). It should be understood that the risk estimation module 305 can be implemented as a physical device or subsystem that is coupled to a processor through a communication channel.

Alternatively, the risk estimation module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the risk estimation module 305 for estimating the financial risk of a project, as described herein with reference to the preceding figures, can be stored on a computer readable storage medium (e.g., RAM, magnetic or optical drive or diskette, and the like).

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

1. A method for estimating a risk associated with a project, the method comprising:
preparing, by a processor, a plurality of data models, wherein each of the plurality of data models examines a different dimension of the project, wherein the risk is a financial risk, wherein the preparing comprises:
completing, for each dimension, a project survey using non-financial data relating to the project, wherein the plurality of data models comprises the project surveys completed for each dimension;
classifying, by the processor, each of the plurality of data models to produce a plurality of prediction models, wherein each of the plurality of prediction models is defined by a plurality of quality metrics, and wherein the plurality of quality metrics includes a preliminary estimate of the risk and a measure of confidence in the preliminary estimate; and
for each of the plurality of prediction models:
assigning, by the processor, a weight to the prediction model based upon a testing of the plurality of quality metrics associated with the prediction module; and
computing, by the processor, a refined estimate of the risk based on a quality of the plurality of quality metrics.

2.-4. (canceled)

5. The method of claim 1, wherein the project survey examines the project prior to a launch of the project.

6. The method of claim 5, wherein at least one of the project surveys comprises a project proposal risk survey that is conducted before the launch.

7. The method of claim 5, wherein at least one of the project surveys comprises a contract risk survey.

8. The method of claim 5, wherein at least one of the project surveys includes a total count of a plurality of risk scores generated from answers to the survey, and wherein the count is categorized on a scale that specifies varying levels of risk.

9. The method of claim 1, wherein at least one of the project surveys examines the project after a launch of the project.

10. The method of claim 9, wherein at least one of the project surveys comprises a standard project assessment conducted by a project manager.

11. The method of claim 9, wherein at least one of the project surveys comprises a detailed project risk assessment conducted by a risk management expert.

12. The method of claim 9, wherein at least one of the project surveys includes a rubric grade in each of a plurality of project progress categories.

13. The method of claim 12, wherein at least one of the project surveys includes an overall grade that aggregates grades assigned to the plurality of project progress categories.

14. The method of claim 12, wherein the plurality of project progress categories includes at least one of: staffing, project scope, schedule adherence, managed project risk, stakeholder commitment, or delivery provider benefits.

15. The method of claim 1, wherein at least one of the project surveys is an overall ongoing assessment of the project that provides an overview of a status of the project.

16. The method of claim 1, wherein the quality of the plurality of quality metrics is represented as the weight.

17. The method of claim 16, wherein the computing comprises multiplying the confidence in the preliminary estimate by the weight.

18. The method of claim 1, wherein the plurality of quality metrics further includes a project identifier and an attribute of an algorithm used in the classifying.

19. The method of claim 1, further comprising:
ranking the project relative to one or more other projects, based on the refined estimate of risk.

20. (canceled)
